(19) United States
(12) Patent Application Publication
(10) Pub. No.: US 2013/0060369 A1
(43) Pub. Date: Mar. 7, 2013

(54) METHOD AND SYSTEM FOR GENERATING INSTRUCTIONS FOR AN AUTOMATED MACHINE

(71) Applicants: Francois Simard, Lorraine (CA); Louis Dicaire, Deux-Montagnes (CA); Samuel Lupien, Mascouche (CA); Dongwook Cho, Pierrefonds (CA); Fabien Danis, Laval (CA)

(72) Inventors: Francois Simard, Lorraine (CA); Louis Dicaire, Deux-Montagnes (CA); Samuel Lupien, Mascouche (CA); Dongwook Cho, Pierrefonds (CA); Fabien Danis, Laval (CA)

(73) Assignee: Advant-Garde Technologie CFMA Inc., Trois-R (CA)

(21) Appl. No.: 13/696,216

(22) PCT Filed: May 10, 2011
(86) PCT No.: PCT/CA2011/000557

§ 371 Date: Nov. 5, 2012

Related U.S. Application Data
(60) Provisional application No. 61/333,830, filed on May 12, 2010.

(51) Int. Cl. G06F 19/00; G06F 17/40

(52) U.S. Cl. 700/98

(57) ABSTRACT

A system and a method for generating instructions for an automated machine adapted for performing a given process on an object are disclosed. The method comprises providing process data representative of the given process to perform; acquiring 3D geometrical data of a portion of the object; generating a model of the portion of the object using the acquired 3D geometrical data; generating a set of instructions for the automated machine according to the generated model and the process data; and providing the set of instructions to the automated machine for performing the given process on the portion of the object. The method may be adapted for cost-effectively automating the manufacturing of a unitary object while taking into consideration actual deformations of the object prior to generate the instructions for the automated machine.

### CROSS REFERENCE TO RELATED APPLICATION

This application claims priority of U.S. Provisional Patent Application Ser. No. 61/333,830 filed on May 12, 2010 and entitled “METHOD AND SYSTEM FOR GENERATING INSTRUCTIONS FOR AN AUTOMATED MACHINE”, the specification of which is hereby incorporated by reference.

### FIELD OF THE INVENTION

The invention relates to a method and a system for generating instructions for an automated machine. It also relates to applications of the method for performing a given manufacturing process on an object.

### BACKGROUND OF THE INVENTION

Methods for programming an industrial robot to move relative to defined positions on an object have been proposed.

Such methods often use a geometric model of the object, also called a theoretical CAD, to provide the robot with a programmed path to perform.

These methods are widely used for manufacturing processes such as welding, gluing, milling, grinding and ever painting as non-limitative examples.

Although well adapted for most applications, these programming methods may however be very time-consuming, which is of great disadvantage. Indeed, in industries wherein the objects to manufacture are mostly manufactured in small batches or as a unitary object, it may not be convenient to program an industrial robot since the time required for programming may be similar or longer than the time required to effectively manually perform the manufacturing operation.

Moreover, in the case wherein the assembly on which the industrial robot has to perform his task is not provided to the robot in the correct position nor has not the correct dimensions, several issues may arise. Indeed, since the operations and the trajectories of the robot are based on a theoretical CAD, collisions between the robot and the assembly may occur, which is not acceptable. Moreover, inadequate positioning of the components of the assembly to manufacture may also occur, which is also not acceptable.

It would therefore be desirable to provide an improved method for generating instructions for an automated machine adapted for performing a given process on an object that would reduce at least one of the above-mentioned drawbacks.

### BRIEF SUMMARY

Accordingly, there is provided a method for generating instructions for an automated machine adapted for performing a given process on an object, the method comprising providing process data representative of the given process to perform; acquiring 3D geometrical data of a portion of the object; generating a model of the portion of the object using the acquired 3D geometrical data; generating a set of instructions for the automated machine according to the generated model and the process data; and providing the set of instructions to the automated machine for performing the given process on the portion of the object.

The method may be adapted for online industrial production, which is of great advantage.

The method may also be well adapted for cost-effectively automating the manufacturing of a unitary object, which is of great advantage.

Moreover, the method may enable to take into consideration actual deformations of the object prior to generate the instructions for the automated machine, which is also of great advantage.

In one embodiment, the method may enable the performing of a given process without knowledge of the theoretical CAD data, which is of great advantage.

In one embodiment, the acquiring of the 3D geometrical data comprises scanning the portion of the object.

In a further embodiment, the acquiring of the 3D geometrical data comprises continuously scanning the portion of the object in a single pass.

In one embodiment, the process data comprise theoretical CAD data of the object and process parameters defining the given process to perform.

In one embodiment, the generating of the model comprises defining a projection plane; and projecting a set of the acquired 3D geometrical data on the defined projection plane to define a synthetic 2D image representative of the object, the synthetic 2D image comprising a plurality of unitary elements, each unitary element being representative of a relative height.

In a further embodiment, a corresponding synthetic 2D image is defined for each side of the object.

In still a further embodiment, the method further comprises creating a 2D theoretical image corresponding to the corresponding synthetic 2D image, based on the theoretical CAD data of the object; comparing the 2D theoretical image to the corresponding synthetic 2D image; and, upon successful comparison of the 2D theoretical image to the corresponding synthetic 2D image, applying a pattern matching algorithm therebetween to provide at least one determined location on the object corresponding to a corresponding one theoretical location on the object; wherein the model is generated according to the at least one determined location.

In one embodiment, the generating of the model comprises using a modeling expert system.

In a further embodiment, the modeling expert system uses at least one control point and at least one control projection plane extracted from the theoretical CAD data of the object.

In one embodiment, during the acquiring of the 3D geometrical data, the object comprises at least one given deformation. In a further embodiment, the given deformation is selected from the group consisting of a flexion, a deflection and a torsion.

In one embodiment, the method further comprises generating a deformed theoretical model of the object according to at least one theoretical deformation corresponding to the at least one given deformation of the object.

In a further embodiment, the generating of the deformed theoretical model of the object comprises using the modeling expert system.

In one embodiment, the method further comprises generating a virtual undeformed model of the portion of the object using the acquired 3D geometrical data and the process data; and controlling at least one dimension of the virtual undeformed model of the portion of the object before performing the given process.

In one embodiment, the set of instructions for the automated machine comprises at least one robot trajectory.

In a further embodiment, the generating of the set of instructions for the automated machine comprises extracting at least one theoretical robot trajectory from the theoretical CAD data and the process parameters; and refining the at least one theoretical robot trajectory according to the generated actual model of the portion of the object to provide a corresponding computed robot trajectory to the automated machine.

In still a further embodiment, the process parameters comprise optimal parameters of the given process to perform and alternative parameters thereof, the generated set of instructions being previously simulated according to an iterative method.

In one embodiment, the generating of the set of instructions for the automated machine comprises using an instruction generation expert system.

In one embodiment, the method further comprises acquiring geometrical data of surroundings of the portion of the object during the acquiring of the 3D geometrical data of the portion of the object.

In one embodiment, the object comprises a structural beam.

In another embodiment, the method may be used for welding at least one accessory on the object.

In one embodiment, the object comprises a structural beam and at least one accessory to be welded thereto, the acquiring of the 3D geometrical data of the portion of the object comprising acquiring 3D geometrical data of the structural beam and acquiring 3D geometrical data of the at least one accessory.

In a further embodiment, the automated machine comprises a welding robot and a pick-and-place robot, the generating of the set of instructions comprising generating pick-and-place instructions for the pick-and-place robot enabling placing of the at least one accessory relatively to the structural beam; and generating welding instructions for the welding robot enabling welding the at least one accessory to the structural beam.

In still a further embodiment, the method further comprises placing the at least one accessory relatively to the structural beam; acquiring joint geometrical data of a joint defined between the structural beam and the at least one accessory; and refining the welding instructions according to the joint geometrical data.

In one embodiment, the method further comprises inspecting the object once the given process has been performed.

According to another aspect, there is also provided the use of the method for generating instructions for an automated machine as defined above for automated welding.

According to another aspect, there is also provided a system for generating instructions for an automated machine adapted for performing a given process on an object. The system comprises a providing unit for providing process data representative of the given process to perform and an acquisition unit for acquiring 3D geometrical data of a portion of the object. The system comprises a model generation unit operatively connected to the acquisition unit for generating a model of the portion of the object using the acquired 3D geometrical data. The system comprises an instruction generation unit operatively connected to the model generation unit and the providing unit for generating a set of instructions for the automated machine enabling to perform the given process on the portion of the object according to the generated model and the process data. The system comprises a control unit operatively connected to the providing unit, the acquisition unit and the instruction generation unit for controlling operation thereof.

In one embodiment, the providing unit comprises a database running on a server.

In one embodiment, the acquisition unit comprises a first scanning device and a second scanning device.

In a further embodiment, each of the scanning devices comprises an imaging unit and a lighting unit.

In still a further embodiment, each of the lighting units comprises a laser beam generator generating a laser plane towards the portion of the object.

In yet a further embodiment, each of the first and the second scanning devices is angularly positioned relatively to the object, the first scanning device being oriented backwardly towards a side of the object, the second scanning device being oriented frontwardly towards another side of the object.

In one embodiment, the model generation unit is operatively connected to the providing unit for receiving the process data and generating the model according to the process data.

In another embodiment, the system further comprises a model expert system operatively connected to the model generation unit for generating the model according to at least one given parameter of the model expert system.

In still another embodiment, the system further comprises an instruction generation expert system operatively connected to the instruction generation unit for generating the set of instructions according to at least one given parameter of the instruction generation expert system.

In one embodiment, the object comprises a structural beam and at least one accessory to be welded thereto.

In one embodiment, the automated machine comprises a welding robot and a pick-and-place robot.

In one embodiment, the automated machine comprises an inspection head for inspecting the object once the given process has been performed.

According to another aspect, there is also provided a computer readable medium comprising a computer program for implementing the above described method.

These and other objects, advantages and features of the present invention will become more apparent to those skilled in the art upon reading the details of the invention more fully set forth below.

### BRIEF DESCRIPTION OF THE DRAWINGS

In order that the invention may be readily understood, embodiments of the invention are illustrated by way of example in the accompanying drawings.

FIG. 1 is a perspective view of an automated machine adapted for performing a given process on an object, according to one embodiment.

FIG. 2 is a block diagram of a system for generating instructions for an automated machine adapted for performing a given process on an object, according to one embodiment.

FIG. 3 shows an exemplary steel beam, according to one embodiment.

FIG. 4 shows another exemplary steel beam, according to another embodiment.

FIG. 5 shows three different cross-sections of the exemplary steel beam of FIG. 4.

FIG. 6 is a perspective view of an acquisition unit of a system for generating instructions, shown in conjunction with a steel beam, according to one embodiment.

FIG. 7 is an isometric view of the acquisition unit shown in FIG. 6.

FIG. 8 is a top view of the acquisition unit shown in FIG. 6.

FIG. 9 is a perspective view of the acquisition unit shown in FIG. 6, shown in conjunction with another steel beam.

FIG. 10A shows a generated 3D cloud of measured points of a portion of the steel beam shown in FIG. 3, in accordance with one embodiment.

FIG. 10B shows a synthetic 2D image, according to one embodiment.

FIG. 10C shows another synthetic 2D image, according to another embodiment.

FIG. 11 is a flow chart of a method for generating instructions for an automated machine, in accordance with one embodiment.

FIGS. 12 to 14 illustrate a flow chart of a method for generating instructions for an automated machine, in accordance with another embodiment.

FIG. 15 is a flow chart of a method for generating instructions for an automated machine, in accordance with still another embodiment.

FIG. 16 is a flow chart of a method for generating instructions for an automated machine, in accordance with yet another embodiment.

Further details of the invention and its advantages will be apparent from the detailed description included below.

### DETAILED DESCRIPTION

In the following description of the embodiments, references to the accompanying drawings are by way of illustration of examples by which the invention may be practiced. It will be understood that various other embodiments may be made and used without departing from the scope of the invention disclosed.

There is disclosed a method and a system for generating instructions for an automated machine adapted for performing a given process on an object.

Throughout the present description, the system and the implementation of the method will be described according to a specific welding application. The skilled addressee will nevertheless appreciate that the method may be used for various other applications, comprising manufacturing applications such as gluing, milling, grinding and ever painting of objects or assemblies as non-limitative examples. The skilled addressee will also appreciate that the method may also be used to perform several processes on the same object. For example, a welding process may be performed before a visual inspection process is done.

Throughout the present description, the term “process” is intended to encompass any task or set of tasks necessary to the manufacturing of an object. The skilled addressee will also appreciate that the term “object” is intended to encompass any working element of any material. Throughout the present description, exemplary methods will be described in conjunction with an application processing a steel beam but it should be understood that various other types of objects of various types of material may be processed, according to the described method.

As it will become apparent to the skilled addressee upon reading the description below, the method may be adapted for online industrial production, which is of great advantage. Moreover, the method may also be well adapted for automating the manufacturing of a unitary object, which is also of great advantage.

In one embodiment, the method may enable to take into consideration actual deformations of the object prior to generate the instructions for the automated machine. This is of great advantage, as it will become apparent below.

As detailed thereinafter, in one embodiment, the method may enable the performing of a given process without knowledge of the theoretical CAD data of the object. This may be useful for reducing processing time in a given application.

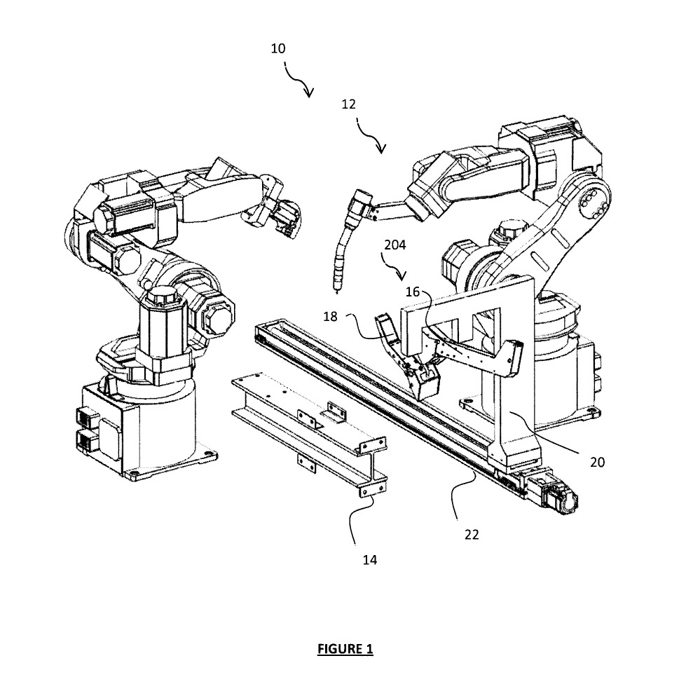

The skilled addressee will also appreciate upon the reading of the description that the automated machine may comprise an industrial robot devised to perform specific operations or any other type of machine or device that may be provided with instructions describing the operations to perform. In one example, the automated machine may comprise a welding robot. In another example which will be described below with reference to FIG. 1, the automated machine may comprise a pick-and-place robot devised to pick and place the components to assemble on the object and a welding robot devised to weld the components on the object. In this case, a support working table may be provided proximate the pick-and-place robot in order to support the components to be mounted on the object prior to their assembling.

Moreover, in such an application, the welding robot may tack the components in place prior to their welding. Alternatively, an additional tacking robot may be provided for tacking the components in place prior to the welding operation. As it will become apparent below to the skilled addressee, such embodiments may be of great advantage since they may enable a visual inspection of the tacked component in order to refine the instructions provided to the welding robot.

In a further embodiment, one of the robots may be provided with an inspection head adapted for inspecting the object once the given process has been performed, as it will become apparent below.

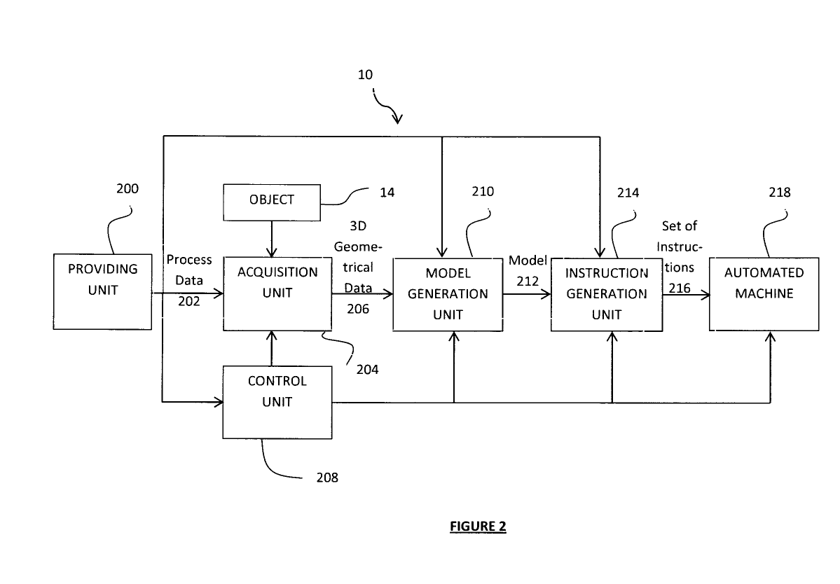

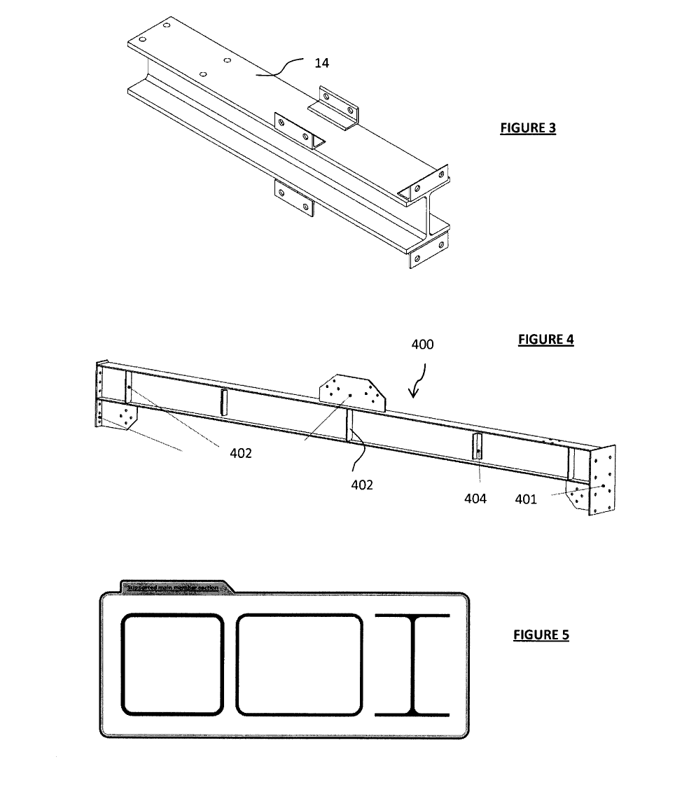

Referring to FIGS. 1 and 2, an embodiment of a system 10 for generating instructions for an automated machine 12 adapted for performing a given process on an object will now be described. In the embodiment illustrated in FIG. 1, the object comprises a structural steel beam 14 but the skilled addressee will appreciate that various other types of object may be considered, as previously mentioned. Various other types of steel beam are shown in FIGS. 3 through 6.

As illustrated in FIG. 2, the system 10 comprises a providing unit 200 for providing process data 202 representative of the given process to perform. In one embodiment, the providing unit 200 may comprise a database running on a server but the skilled addressee will appreciate that various other arrangements may be considered without departing from the scope of the invention.

In the case where the system 10 is used in a welding application, the process data 202 may comprise theoretical CAD data representative of the theoretical object, as it will be more detailed thereinafter.

In a further embodiment, the process data 202 may also comprise process parameters and various data defining the given process to perform, as further detailed below.

The system 10 comprises an acquisition unit 204 for acquiring 3D geometrical data 206 of a portion of the object 14. In one embodiment, the acquisition unit 204 is operatively connected to the providing unit 200 for receiving the process data 202 or a suitable portion thereof. For example, the transmitted process data 202 may comprise data relative to the resolution of the acquisition needed for a given application.

As it should become apparent below, in one embodiment and according to a given application, only a portion of the object onto which processing steps have to be performed may be scanned, according to the given process to perform.

In another embodiment, the complete 3D envelope of the object may be scanned, as detailed below. Moreover, in a further embodiment, geometrical data of surroundings of the portion of the object may be acquired during the acquiring of the 3D geometrical data 206 of the portion of the object. This may be of great advantage in applications wherein the automated machine has to move in the vicinity of the object, as detailed below.

The skilled addressee will appreciate that a single face of the object 14 may be scanned, according to a given application.

In the embodiment illustrated in FIG. 1, the acquisition unit 204 comprises a first scanning device 16 and a second scanning device 18 attached on a supporting arm 20. The arm 20 is slidably mounted on a slide 22 which, in an embodiment, is fixed proximate a support (not shown) adapted to support the structural steel beam 14.

In this embodiment, a control unit 208, shown in FIG. 2, is operatively connected to the acquisition unit 204 in order to control an operation thereof. For example, the control unit 208 may control the speed at which the acquisition unit 204 is moved on the slide 22. In one embodiment, the acquisition unit 204 is moved in order to continuously acquire the 3D geometrical data 206 in a single pass. Alternatively and as mentioned above, appropriate data may be provided to the acquisition unit 204 by the providing unit 200.

As shown in FIG. 2, the system 10 comprises a model generation unit 210 operatively connected to the acquisition unit 204 for generating a model 212 of the scanned portion of the object 14 using the acquired 3D geometrical data 206.

In one embodiment, the model generation unit 210 may be connected to at least one of the providing unit 200 and the control unit 208 for receiving parameters related to the generation of the model 212, as detailed thereinafter.

The system 10 comprises an instruction generation unit 214 operatively connected to the model generation unit 210 for receiving the model 212 and to the providing unit 200 for receiving the process data 202. The instruction generation unit 214 generates a set of instructions 216 for the automated machine 218 enabling to perform the given process on the portion of the object 14 according to the generated model 212 and the process data 202.

In one embodiment, the instruction generator unit 214 is operatively connected to the control unit 208 for receiving additional data related to the generation of the set of instructions 216, as it will become apparent thereinafter.

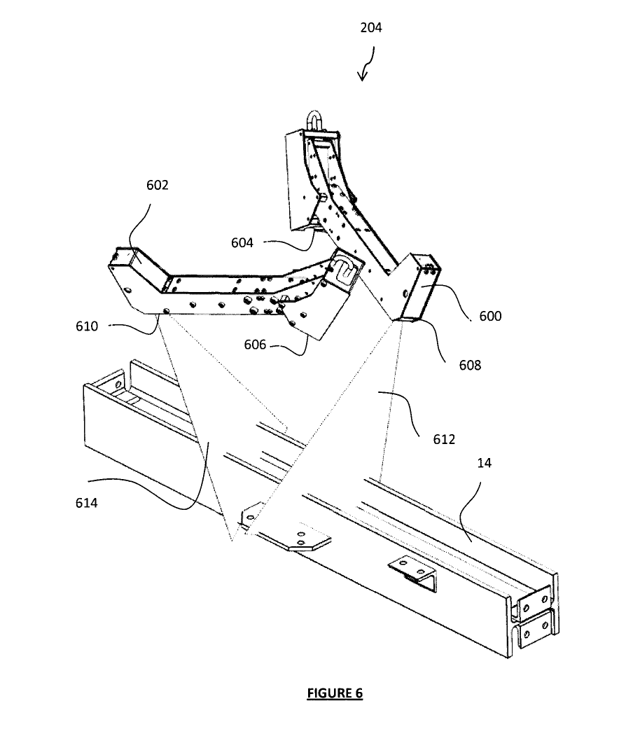

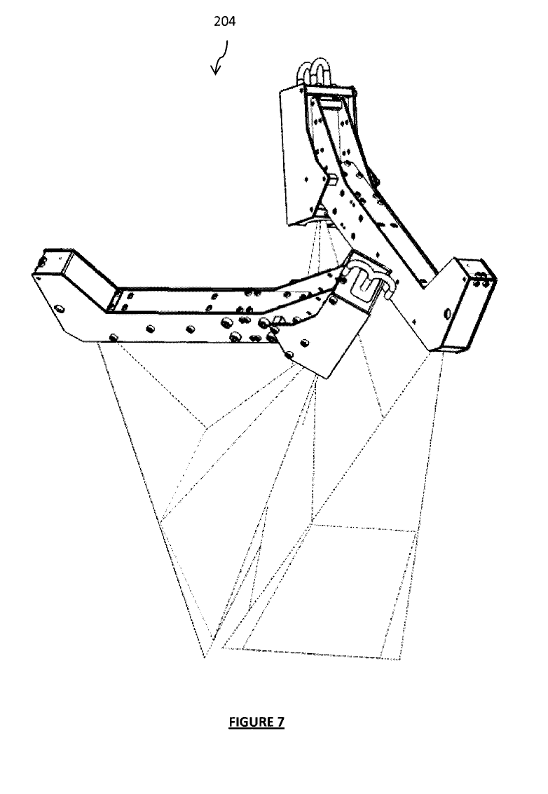

FIG. 3 shows an exemplary embodiment of an object, which is, in the present case, a structural steel beam 14 similar to the one shown in FIG. 1. FIG. 4 shows another embodiment of a structural steel beam on which a given process may be performed while FIG. 5 shows various cross-sections of the steel beam of FIG. 4.

Referring to FIG. 4, in one embodiment, the given process may comprise welding three stiffeners 402 and two angles 404 to a face of the steel beam 400, as a non-limitative example.

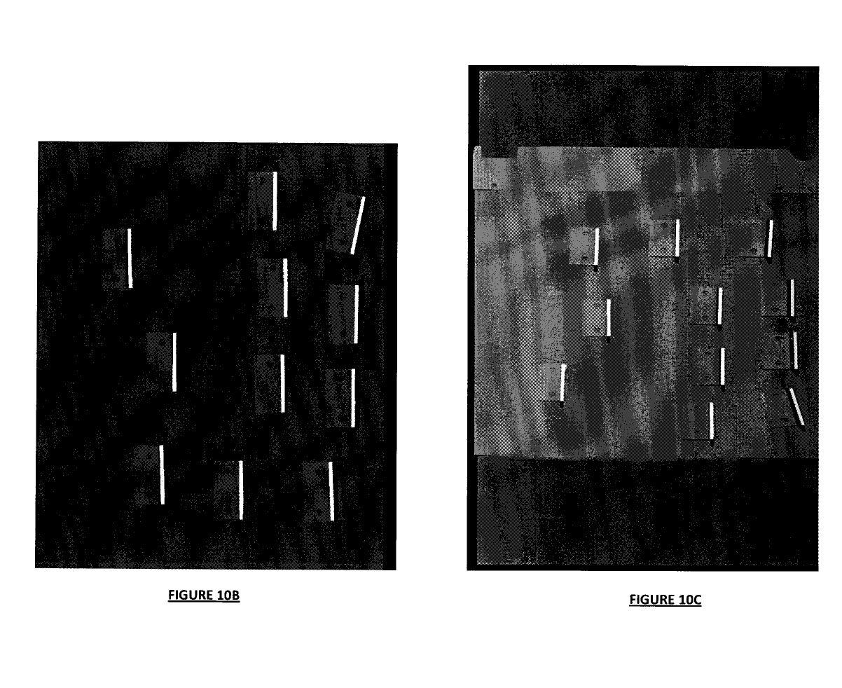

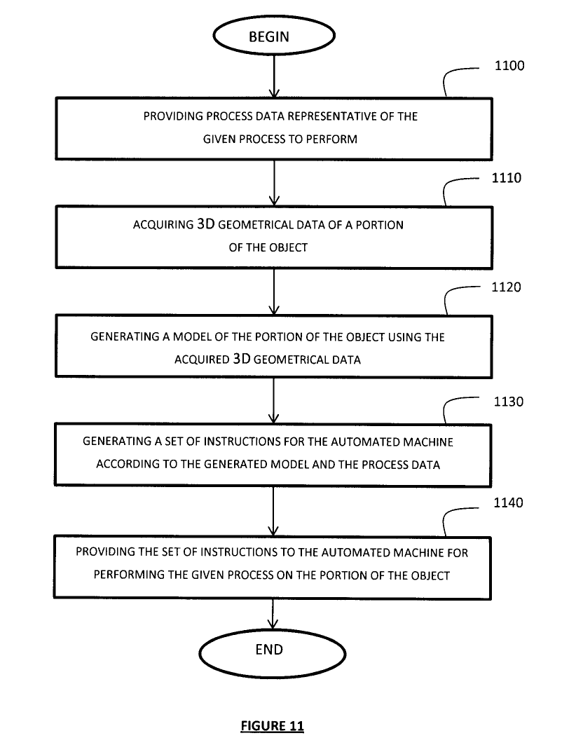

FIG. 10A shows a generated 3D cloud of measured points of a top portion of the steel beam 14 of FIG. 3 obtained with the system 10 of FIG. 2. As shown, the 3D cloud of measured points of the top portion comprises 2D information such as the positioning of holes and sub-parts, as well as 3D information such as the height of the sub-parts, as it will become apparent below.

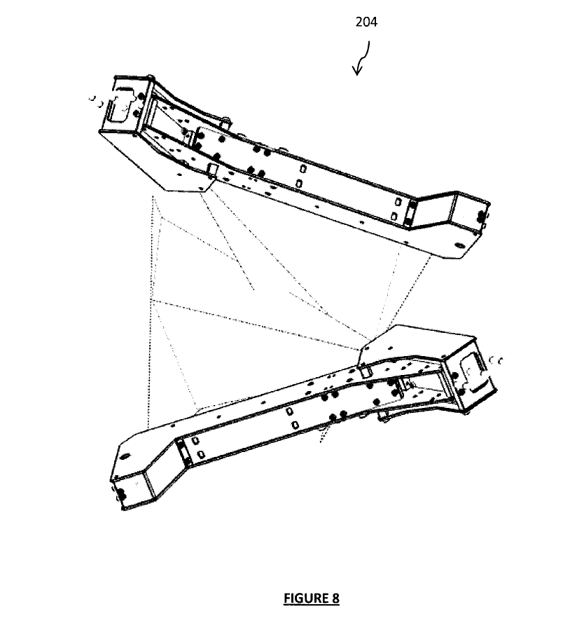

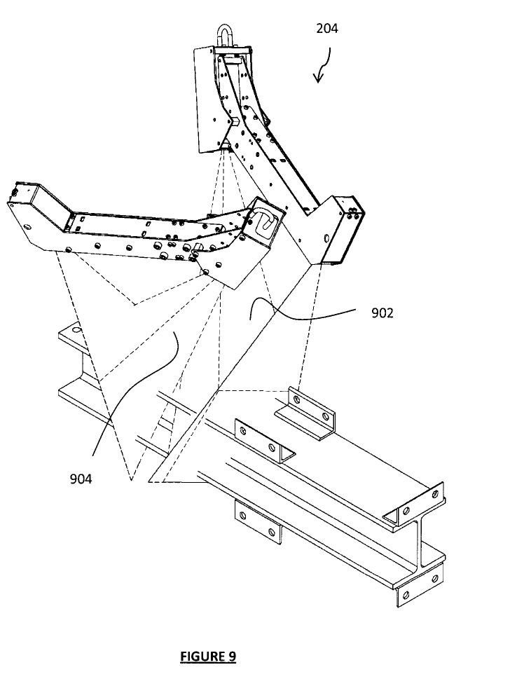

Referring now to FIGS. 6 to 9 and again to FIG. 1, in one embodiment, as previously mentioned, the acquisition unit 204 comprises a first scanning device 600 and a second scanning device 602. As described above, the acquisition unit 204 may be displaced along the object 14. Alternatively, the acquisition unit 204 may be immovably fixed to a frame (not shown) of the system while the object 14 is displaced relatively to the acquisition unit 204.

In one embodiment and as illustrated, each of the first and second scanning devices 600, 602 comprises an imaging unit 604, 606 such as a camera and an associated lighting unit 608, 610. In one embodiment, each of the lighting unit 608, 610 comprises a laser beam generator generating a laser plan 612, 614 towards the portion of the object 14.

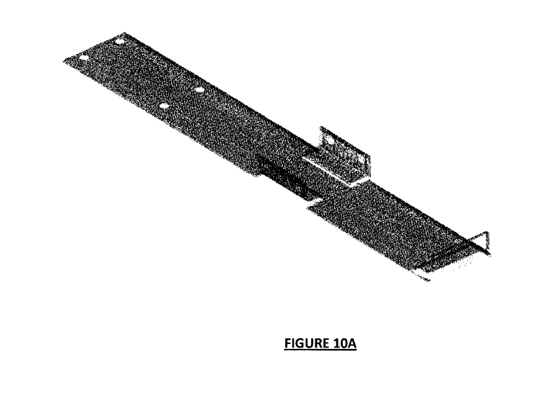

In one embodiment, as shown in FIG. 1, the laser beam generators are mounted on the supporting arm 20 for directing the laser plans 612, 614 towards the object 14. The camera is mounted on the supporting arm 20 such that the projected light beam is reflected in the field of view 902, 904 of the camera (shown in FIG. 9).

In a further embodiment, each scanning device 600, 602 is independent from the other one. In other words, the light beam 612 projected by the first laser beam generator 608 is reflected in the field of view 902 of the first camera 604 but does not reach the field of view 904 of the second camera 606. Similarly, the light beam 614 projected by the second laser beam generator 610 is reflected in the field of view 904 of the second camera 606 but does not reach the field of view 902 of the first camera 604.

Moreover, as illustrated, in one embodiment, the first and the second scanning devices 600, 602 extend angularly with respect to the object 14. In a further embodiment, the first scanning device 600 is oriented backwardly towards the left while the second scanning device 602 is oriented frontwardly towards the right. This arrangement is of great advantage since it greatly reduces shadow and occlusion effects generally associated to laser scanning while enabling a complete and continuous 3D scanning of the corresponding portion of the object in a single pass.

It should be mentioned that the scanning devices are chosen and the scanning operations are performed in order to enable the generation of the model 212 according to a specific resolution. Indeed, for a given application wherein accurate positioning and welding is needed, a high resolution scanning is performed in order to be able to generate a high density 3D model.

The acquisition of the 3D geometrical data 206 has been described using artificial vision but the skilled addressee will nevertheless appreciate that various other types of acquisition may be envisaged, depending on the given object. For non-limitative examples, radar techniques or tomographic techniques may be considered.

In a further embodiment, expert systems may be used for generating the model 212 and the set of instructions 216, as it will become apparent below.

For example, in one embodiment that will be detailed below, the system 10 further comprises a model expert system operatively connected to the model generation unit 210 for generating the model 212 according to at least one given parameter of the model expert system, as detailed thereinafter.

In a further embodiment, the system 10 further comprises an instruction generation expert system operatively connected to the instruction generation unit 214 for generating the set of instructions 216 according to at least one given parameter of the instruction generation expert system, as detailed thereinafter.

A method for generating instructions for an automated machine adapted for performing a given process on an object will now be described below. The skilled addressee will appreciate that the system 10 shown in FIG. 2 and described above may be used, although other arrangements may be considered.

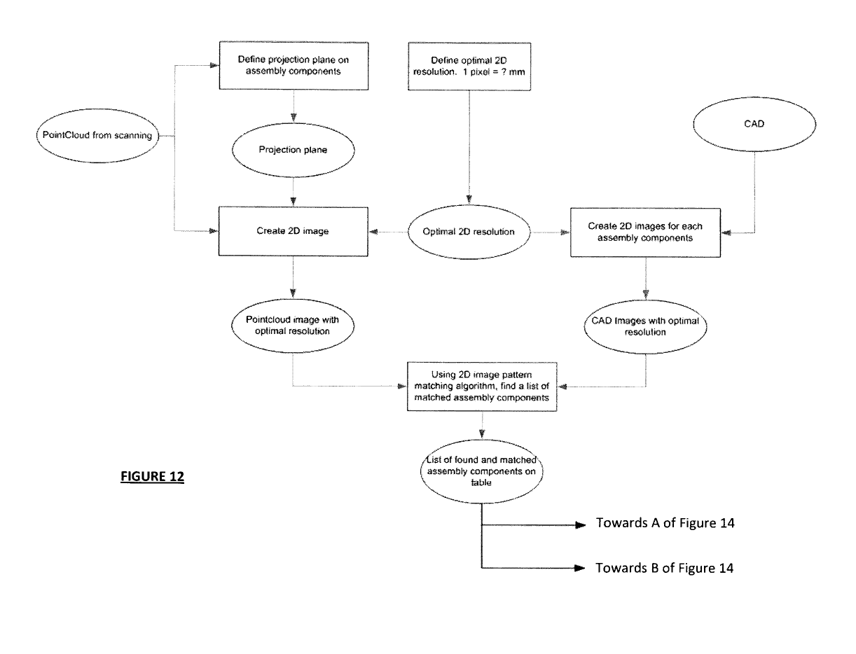

As illustrated in FIG. 11, according to processing step 1100, process data representative of the given process to perform are provided.

According to processing step 1110, 3D geometrical data of a portion of the object are acquired.

According to processing step 1120, a model of the portion of the object is generated using the acquired 3D geometrical data.

According to processing step 1130, a set of instructions is generated for the automated machine, according to the generated model and the process data.

According to processing step 1140, the set of instructions is provided to the automated machine for performing the given process on the portion of the object.

The skilled addressee will appreciate that the above described method is of great advantage over the conventional methods generally used in the art.

Indeed, once processing step 1120 has been performed, the portion of the object on which a given process has to be performed may be accurately known in shape and size without requiring the theoretical CAD data, which is of great advantage as it will become apparent below.

For example, in a given application wherein the process comprises deburring the edges of the object for a non-limitative example, the theoretical CAD data comprising precise location of the sub-parts on the main part may be omitted. In this case, the method enables a fast process, as it will become more apparent below.

Moreover, in the case of manufacturing unique or unitary structural steel beams, conventional automated methods may not be used due to the time consuming programming procedure. In this case, the steel beams are often manually assembled by operators. With the method described above, manufacturing of unique piece may be automated without undue time consuming programming, which is of great advantage.

Moreover, in one embodiment, as described above, the working area extending around the object may also be known, which is of great advantage for generating the instructions to the automated machine while ensuring that the instructions does not generate collisions which may damage the object and even the automated machine. Such collisions may occur with conventional methods, as it will become apparent below.

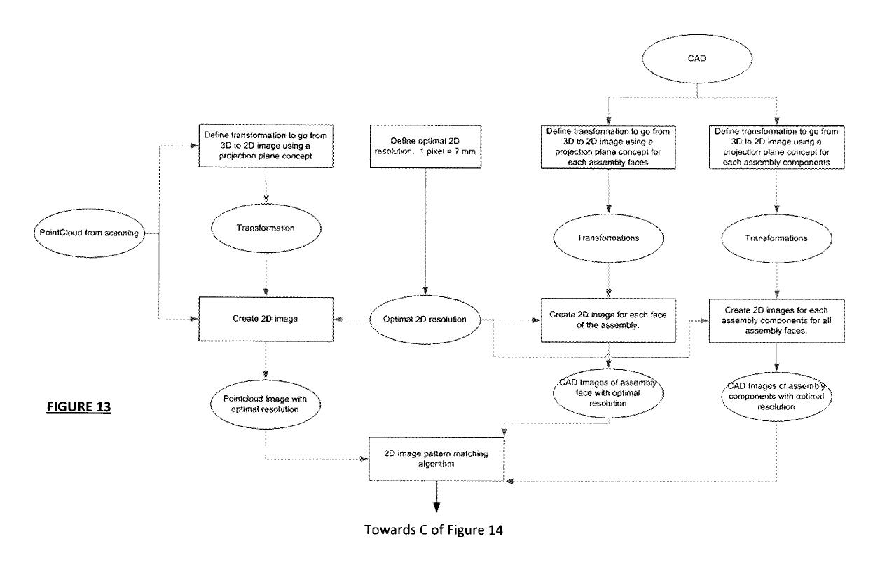

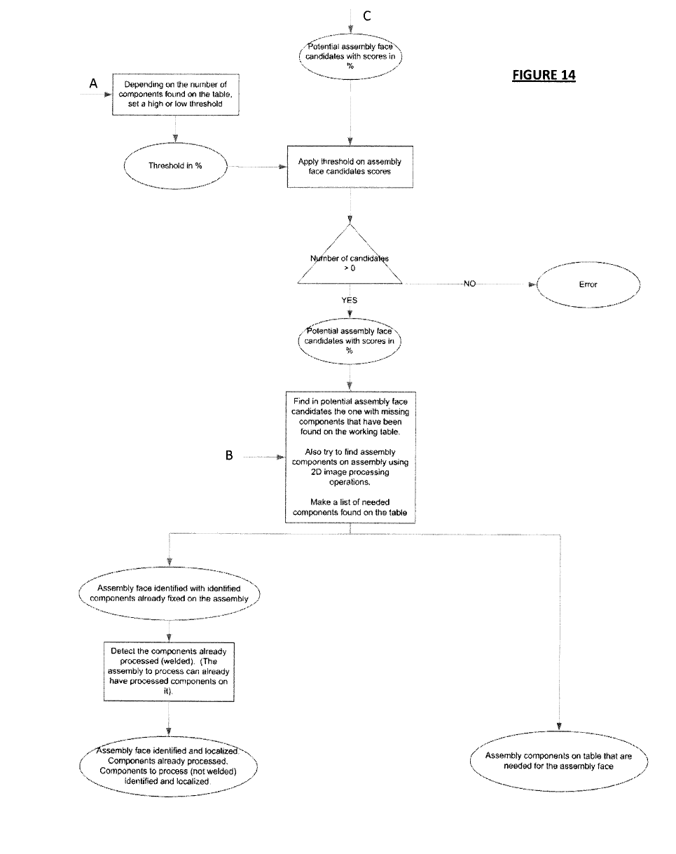

Still referring to FIG. 11 and also to FIGS. 12 to 16, a preferred embodiment of a method for generating instructions for an automated machine will now be described.

In this embodiment, the method is used to complete welding of a structural steel assembly. The sub-parts of the assembly may be fixed thereto with weld points or they may also be put on a working table. As illustrated in FIG. 1, two robots are needed for this application, a welding robot for performing the welding and a pick-and-place robot for manipulating and holding the accessories.

As previously mentioned, a suitable scanning is performed in order to acquire the 3D geometrical data representative of a real portion of the object. At this point, a 3D cloud of measured points is obtained.

The skilled addressee will appreciate that the pick-and-place robot may be provided with a scanning device for acquiring 3D geometrical data of the accessories prior to their placing. The skilled addressee will nevertheless appreciate that various other arrangements for identifying each accessory may be considered.

In order to generate the model, in one embodiment, a modeling expert system may be implemented, as described above, although other processing devices may be considered.

In a further embodiment, the modeling expert system may use at least one control point and at least one control projection plane extracted from the theoretical CAD data of the object, as detailed below.

For example, in one embodiment, the modeling expert system may assume that the structural steel beam and the associated accessories comprise four different sides having given edges, each of which being stable in nature, as shown in FIGS. 3 to 5. In a further embodiment, the modeling expert system may assume that the main surfaces of the structural steel beam extend at right angle with respect to each other, as it will become apparent below to the skilled addressee.

In one embodiment, the method is implemented for each side of the steel beam onto which a processing step has to be performed. In the embodiments shown in FIGS. 1, 9 and 10, the face of the beam projecting upwardly is scanned.

In one embodiment, once the 3D geometrical data have been acquired and the 3D cloud of measured points has been obtained, a synthetic 2D image representative of the object is created. FIGS. 10B and 10C show two different synthetic images that have been created. In one embodiment, the synthetic 2D image comprises a plurality of unitary elements, each unitary element being representative of a relative height of a corresponding point of the portion of the object.

In one embodiment, in order to create this synthetic 2D image, the modeling expert system defines at least one projection plane on the object. Once the projection plane has been defined, the 3D geometrical data or a portion thereof are projected on a x-y plane along the projection plane, the intensity of each pixel being representative of the height of the components of the object. For example, as shown in FIGS. 10B and 10C, in a 8 bits image, pixels having a value close to 0 represent a real point whose real relative height equals to 0 while pixels whose value is close to 255 represent a real point whose relative height is maximal with respect to the surroundings. The skilled addressee will nevertheless appreciate that in the illustrated embodiments, pixels having a zero value may represent shadowed zones for which measured points may not be acquired within the given image.

This processing step of creating a synthetic 2D image representative of the object is of great advantage since it may enable using 2D algorithms which are greatly faster than 3D algorithms. In the meantime, 3D information is still preserved. In one embodiment, a plurality of synthetic 2D images may be created, as it should become apparent to the skilled addressee. For example, synthetic 2D images of appropriate sides of the accessories may also be provided.

In the meantime, 2D theoretical images are created for each accessory of the object or portion thereof which may be useful for the generation of the model, based on the theoretical CAD data of the object.

Depending on the given accuracy required by the given process, a given 2D resolution may be determined.

Then, if necessary, the synthetic 2D images and the 2D theoretical images may be resized, as well known in the art.

Then, the synthetic 2D images and the corresponding 2D theoretical images may be compared. The skilled addressee will appreciate that the present method alleviates the concern of a bad orientation of the object or a misplacing thereof since the comparison of the synthetic 2D image with the corresponding theoretical CAD data enables to recognize which face of the steel beam has been scanned. Moreover, extra parts or foreign object may be identified if present as, in one embodiment, the entire working volume surrounding the steel beam is digitized, thereby enabling collision avoidance with those objects. This is of great advantage since it may prevent the system from blindly performing the given process, as it should become apparent to the skilled addressee.

Upon successful comparison of the 2D theoretical image to the corresponding synthetic 2D image, a pattern matching algorithm may be applied therebetween to provide at least one determined location on the object corresponding to a corresponding one theoretical location on the object. Then, the model may be generated according to the at least one determined location. The determined location may be a specific location on the steel beam in which components have to be welded. Alternatively, the determined locations may correspond to given control points, for example derived from the geometry of the steel beam.

At this point, the scanned face of the steel beam as well as the positioning of the components have been roughly identified. Although rough, this identification may be very fast while very robust thanks to the use of the created 2D synthetic images which enable using fast 2D algorithms.

The skilled addressee will appreciate that the processing steps described above may be repeated for each of the remaining faces of the structural steel beam, as needed by the given application. At this point, each side of the structural steel beam has been scanned and real 3D information is known.

It is known in the art that structural steel beams may be very long and very heavy. They are thus subject to temporary deformation such as flexion, deflection or torsion, even if simply disposed on a support.

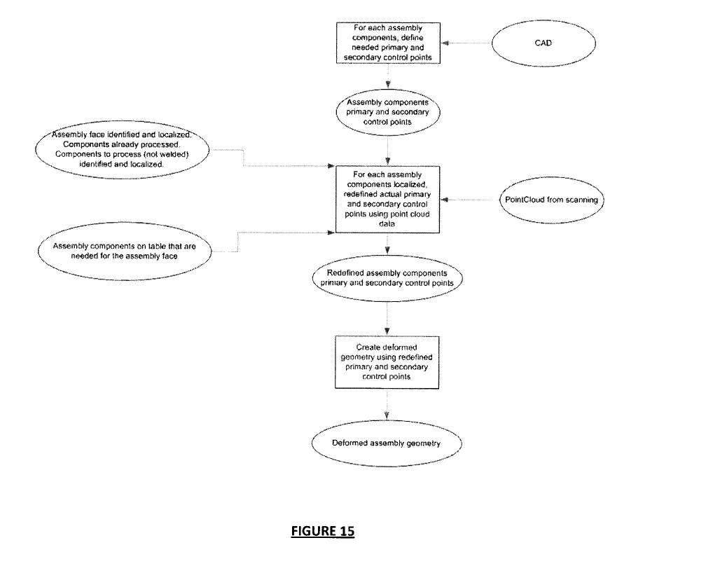

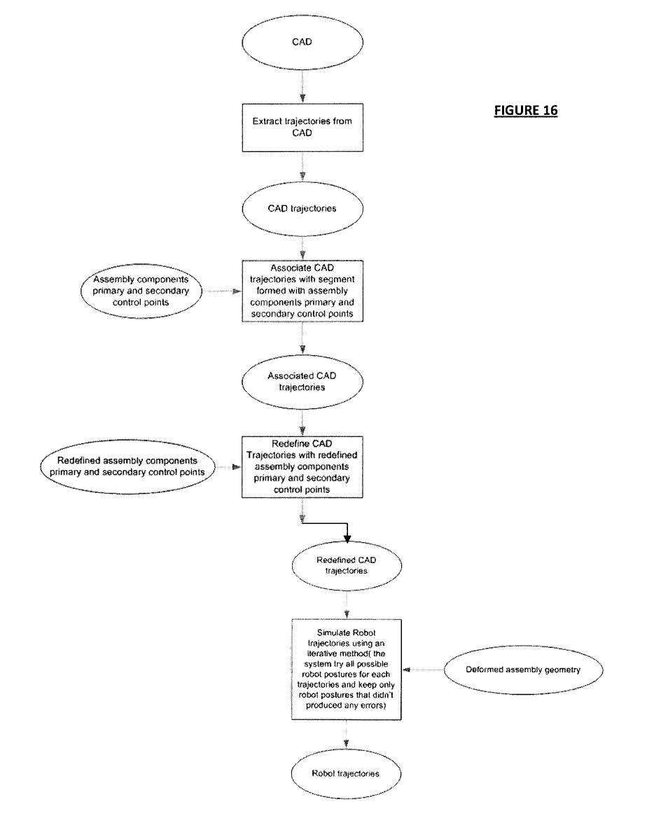

Referring now to FIG. 15, a further embodiment of the method which takes into consideration actual deformations of the steel beam for generating an accurate model thereof will now be described.

In this embodiment, the modeling expert system generates a deformed theoretical model of the object according to at least one theoretical deformation corresponding to the at least one given deformation of the object. For example, if the two ends of an elongated heavy steel beam are placed on blocks, the central portion of the steel beam may present a temporary downwards flexion due to gravity. In this case, a theoretical deformation of the object as well as other specificities thereof may be used by the modeling expert system to generate the deformed theoretical model according to the scanning conditions.

The deformed theoretical model may be used in conjunction with a pattern matching algorithm in order to refine the model of the portion of the object.

Indeed, as mentioned above, the expert system generates the model using projection planes and control points. As it should become apparent to the skilled addressee, the given geometry of the steel beam and of the accessories may be useful for determining the projection planes. Moreover, the control points may be conveniently chosen for enabling an accurate construction of the model. For example, in the case where the component is a corner plate, the control points may be chosen at each vertex of the corner plate. Control points are chosen to simplify CAD model while retaining functional edges. Thus, an angle can be modelized as a 12 point solid, 6 on each “L” end. To properly represent bending or change in thickness, no constraints are given to those points so they can represent more than simple extrusion. Filet and chamfer are ignored in one embodiment. For long parts, arbitrary control planes may be created at any given length to allow modeling of bending and twisting along extrusion axis.

Based on the theoretical CAD data and the theoretical deformation, theoretical control points are defined for the object and each accessory thereof.

Based on the acquired 3D geometrical data, actual corresponding control points are defined on the object and each accessory thereof.

Then, using the theoretical control points and the actual control points, the actual deformed model is generated.

In one embodiment, a virtual undeformed model of the scanned portion of the object may be generated using the acquired 3D geometrical data, the process data and/or the data relative to the theoretical deformation. In other words, the generated model may be virtually redressed as if it was mechanically redressed.

Then, at least one dimension of the virtual undeformed model of the portion of the object may be controlled before performing the given process.

This step may be of great advantage to ensure that the steel beam is within the mechanical specifications before performing further processing thereon. In the case where the scanned steel beam is not manufactured according to the specification, the system may stop the processing and alert the operator or an administrator of the system.

At this point, the generation of robot trajectories is performed. The skilled addressee will appreciate that the method is of great advantage since the trajectories are generated on the actual model taken deformations of the object into consideration. This is particularly advantageous in the case the object on which the process is performed is temporarily deformed. Indeed, with conventional methods, since the actual position of the joint to weld is not known, joint tracking has to be performed prior to welding.

In one embodiment, the trajectories of the robot are generated as follows.

Referring to FIG. 16, at least one theoretical robot trajectory is extracted from the theoretical CAD data and the process parameters.

Then, the generated actual model of the object and the control points that have been previously determined are used to refined the at least one theoretical robot trajectory to provide a corresponding computed robot trajectory to the automated machine.

Process data generally include 3D path in space associated with specific CAD geometry. Using the generated actual model, those paths may be precisely placed in respect with real parts and re-dimensioned to the generated actual model size and deformation.

For many processes, only 5 axes are defined in process data, leaving an infinite number of possible robot postures to perform this process. Moreover, a robot could use several arm posture for any single 6 axis path. This give freedom to optimize tool orientation and posture to avoid arm reach limit, collision or singularities, as detailed below.

The generated actual model of the object is used to verify that the proposed theoretical robot trajectories do not lead to collisions with the object or the surroundings thereof.

In one embodiment, based on the generated actual model, the system may simulate the possible robot trajectories using an iterative method. In other words, the system may try all possible robot postures and a number of tool orientations for each trajectory and keep only the robot postures that did not produce any errors.

For example, during a welding operation, it is preferred to move the welding tool according to a specific direction and with a specific angle with respect to the joint. Such process parameters, which may comprise optimal parameters of the given process to perform and alternative parameters thereof, may be provided to the instruction generation expert system. The instruction generation expert system will take these process parameters into consideration for generating the robot trajectories. If a preferred trajectory cannot be implemented, the instruction generation expert system will rely on alternative parameters relative to the positioning of the welding tool for generating a complete set of instructions related to the robot trajectories.

In one embodiment, the set of instructions is simulated according to an iterative method prior to be generated.

Once the complete set of instructions has been generated, the set of instructions is provided to the automated machine for performing the welding process according to the determined trajectories.

In an embodiment wherein the automated machine comprises a welding robot and a pick-and-place robot, the generating of the set of instructions may comprise generating pick-and-place instructions for the pick-and-place robot enabling placing of the at least one accessory relatively to the structural beam and generating welding instructions for the welding robot enabling welding the at least one accessory to the structural beam.

In a further embodiment, once the accessory has been placed relatively to the structural beam, joint geometrical data of a joint defined between the structural beam and the accessory may be acquired. Then, the welding instructions may be refined according to the joint geometrical data. As a non-limitative example, the gap between the accessory and the structural beam may be determined along the weld path in order to vary welding parameters accordingly. This makes it possible to successfully weld deformed parts, as they exist in real life situation. In one embodiment, a dual scanner similar to the one shown in FIG. 9 may be mounted on the welding robot in order to perform weld join localisation and characterization. The skilled addressee will nevertheless appreciate that other arrangements may be considered.

In still a further embodiment, a post visual inspection of the performed given process may be implemented. This inspection may be performed with an inspection head mountable on the welding robot. Alternatively, the processed object may be scanned again with the acquisition unit.

In still a further embodiment, a plurality of robots, each performing a given process, may be used for implementing various processes to be performed on the object.

In yet a further embodiment, various data related to the acquisition, the generation of the model and of the set of instructions, the actual deformation encountered and any other types of information may be recorded and stored for further processing. For non-limitative examples, these data may be used for quality assessment, model prediction and parameters monitoring. In one embodiment, the cloud of measured point may be used by third party software for reverse engineering or geometrical dimensioning and tolerancing (GD&T) or yet creating a deformation mapping by comparing the original model to the actual part.

The skilled addressee will appreciate that the above described method is of particular interest since it may help implementing automated process without requiring experimented operators, which is of great advantage. The manufacturing time may be greatly reduced while the quality of the manufacturing may be greatly enhanced.

The skilled addressee will also appreciate that the disclosed method may be particularly cost-effective for unitary piece manufacturing.

According to another aspect, there is also provided a computer readable medium comprising a computer program for implementing the above described method.

Although the above description relates to specific preferred embodiments as presently contemplated by the inventors, it will be understood that the invention in its broad aspect is not limited to this specific embodiment and includes mechanical and functional equivalents of the elements described herein.

What is claimed is:

1. A method for generating instructions for an automated machine adapted for performing a given process on an object, the method comprising:
providing process data representative of the given process to perform;
acquiring 3D geometrical data of a portion of the object;
generating a model of the portion of the object using the acquired 3D geometrical data;
generating a set of instructions for the automated machine according to the generated model and the process data; and
providing the set of instructions to the automated machine for performing the given process on the portion of the object.

2. The method for generating instructions for an automated machine according to claim 1, wherein the acquiring of the 3D geometrical data comprises scanning the portion of the object.

3. The method for generating instructions for an automated machine according to claim 1, wherein the acquiring of the 3D geometrical data comprises continuously scanning the portion of the object in a single pass.

4. The method for generating instructions for an automated machine according to any one of claims 1 to 3, wherein the process data comprise theoretical CAD data of the object and process parameters defining the given process to perform.

5. The method for generating instructions for an automated machine according to claim 4, wherein the generating of the model comprises:
defining a projection plane; and
projecting a set of the acquired 3D geometrical data on the defined projection plane to define a synthetic 2D image representative of the object, the synthetic 2D image comprising a plurality of unitary elements, each unitary element being representative of a relative height.

6. The method for generating instructions for an automated machine according to claim 5, wherein a corresponding synthetic 2D image is defined for each side of the object.

7. The method for generating instructions for an automated machine according to any one of claims 5 to 6, further comprising:
creating a 2D theoretical image corresponding to the corresponding synthetic 2D image, based on the theoretical CAD data of the object;
comparing the 2D theoretical image to the corresponding synthetic 2D image; and
upon successful comparison of the 2D theoretical image to the corresponding synthetic 2D image, applying a pattern matching algorithm therebetween to provide at least one determined location on the object corresponding to a corresponding one theoretical location on the object;
wherein the model is generated according to the at least one determined location.

8. The method for generating instructions for an automated machine according to any one of claims 5 to 7, wherein the generating of the model comprises using a modeling expert system.

9. The method for generating instructions for an automated machine according to claim 8, wherein the modeling expert system uses at least one control point and at least one control projection plane extracted from the theoretical CAD data of the object.

10. The method for generating instructions for an automated machine according to any one of claims 8 to 9, wherein, during the acquiring of the 3D geometrical data, the object comprises at least one given deformation.

11. The method for generating instructions for an automated machine according to claim 10, wherein the given deformation is selected from the group consisting of a flexion, a deflection and a torsion.

12. The method for generating instructions for an automated machine according to any one of claims 10 to 11, further comprising generating a deformed theoretical model of the object according to at least one theoretical deformation corresponding to the at least one given deformation of the object.

13. The method for generating instructions for an automated machine according to claim 12, wherein the generating of the deformed theoretical model of the object comprises using the modeling expert system.

14. The method for generating instructions for an automated machine according to any one of claims 10 to 13, further comprising:
generating a virtual undeformed model of the portion of the object using the acquired 3D geometrical data and the process data; and
controlling at least one dimension of the virtual undeformed model of the portion of the object before performing the given process.

15. The method for generating instructions for an automated machine according to any one of claims 4 to 14, wherein the set of instructions for the automated machine comprises at least one robot trajectory.

16. The method for generating instructions for an automated machine according to claim 15, wherein the generating of the set of instructions for the automated machine comprises:
extracting at least one theoretical robot trajectory from the theoretical CAD data and the process parameters; and
refining the at least one theoretical robot trajectory according to the generated actual model of the portion of the object to provide a corresponding computed robot trajectory to the automated machine.

17. The method for generating instructions for an automated machine according to claim 16, wherein the process parameters comprise optimal parameters of the given process to perform and alternative parameters thereof, the generated set of instructions being previously simulated according to an iterative method.

18. The method for generating instructions for an automated machine according to claim 17, wherein the generating of the set of instructions for the automated machine comprises using an instruction generation expert system.

19. The method for generating instructions for an automated machine according to any one of claims 1 to 18, further comprising acquiring geometrical data of surroundings of the portion of the object during the acquiring of the 3D geometrical data of the portion of the object.

20. The method for generating instructions for an automated machine according to any one of claims 1 to 19, wherein the object comprises a structural beam.

21. The method for generating instructions for an automated machine according to any one of claims 1 to 20 for welding at least one accessory on the object.

22. The method for generating instructions for an automated machine according to any one of claims 4 to 19, wherein the object comprises a structural beam and at least one accessory to be welded thereto, the acquiring of the 3D geometrical data of the portion of the object comprising acquiring 3D geometrical data of the structural beam and acquiring 3D geometrical data of the at least one accessory.

23. The method for generating instructions for an automated machine according to claim 22, wherein the automated machine comprises a welding robot and a pick-and-place robot, the generating of the set of instructions comprising:
generating pick-and-place instructions for the pick-and-place robot enabling placing of the at least one accessory relatively to the structural beam; and
generating welding instructions for the welding robot enabling welding the at least one accessory to the structural beam.

24. The method for generating instructions for an automated machine according to claim 23, further comprising:
placing the at least one accessory relatively to the structural beam;
acquiring joint geometrical data of a joint defined between the structural beam and the at least one accessory; and
refining the welding instructions according to the joint geometrical data.

25. The method for generating instructions for an automated machine according to any one of claims 1 to 24, further comprising inspecting the object once the given process has been performed.

26. Use of the method for generating instructions for an automated machine as defined in any one of claims 1 to 25 for automated welding.

27. A system for generating instructions for an automated machine adapted for performing a given process on an object, the system comprising:
a providing unit for providing process data representative of the given process to perform;
an acquisition unit for acquiring 3D geometrical data of a portion of the object;
a model generation unit operatively connected to the acquisition unit for generating a model of the portion of the object using the acquired 3D geometrical data;
an instruction generation unit operatively connected to the model generation unit and the providing unit for generating a set of instructions for the automated machine enabling to perform the given process on the portion of the object according to the generated model and the process data; and
a control unit operatively connected to the providing unit, the acquisition unit and the instruction generation unit for controlling operation thereof.

28. The system for generating instructions for an automated machine according to claim 27, wherein the providing unit comprises a database running on a server.

29. The system for generating instructions for an automated machine according to any one of claims 27 to 28, wherein the acquisition unit comprises a first scanning device and a second scanning device.

30. The system for generating instructions for an automated machine according to claim 29, wherein each of the scanning devices comprises an imaging unit and a lighting unit.

31. The system for generating instructions for an automated machine according to claim 30, wherein each of the lighting units comprises a laser beam generator generating a laser plane towards the portion of the object.

32. The system for generating instructions for an automated machine according to claim 31, wherein each of the first and the second scanning devices is angularly positioned relatively to the object, the first scanning device being oriented backwardly towards a side of the object, the second scanning device being oriented frontwardly towards another side of the object.

33. The system for generating instructions for an automated machine according to any one of claims 27 to 32, wherein the model generation unit is operatively connected to the providing unit for receiving the process data and generating the model according to the process data.

34. The system for generating instructions for an automated machine according to any one of claims 27 to 33, further comprising a model expert system operatively connected to the model generation unit for generating the model according to at least one given parameter of the model expert system.

35. The system for generating instructions for an automated machine according to any one of claims 27 to 34, further comprising an instruction generation expert system operatively connected to the instruction generation unit for generating the set of instructions according to at least one given parameter of the instruction generation expert system.

36. The system for generating instructions for an automated machine according to any one of claims 27 to 35, wherein the object comprises a structural beam.

37. The system for generating instructions for an automated machine according to any one of claims 27 to 35, wherein the object comprises a structural beam and at least one accessory to be welded thereto.

38. The system for generating instructions for an automated machine according to any one of claims 27 to 37, wherein the automated machine comprises a welding robot and a pick-and-place robot.

39. The system for generating instructions for an automated machine according to any one of claims 27 to 38, wherein the automated machine comprises an inspection head for inspecting the object once the given process has been performed.

40. A computer readable medium comprising a computer program for implementing the method as defined in claims 1 to 25.
